(19) United States
(12) Patent Application Publication
(10) Pub. No.: US 2022/0414663 A1
(43) Pub. Date: Dec. 29, 2022

(54) COMPARATIVE FEATURES FOR MACHINE LEARNING BASED CLASSIFICATION

(71) Applicant: Intuit Inc., Mountain View, CA (US)

(72) Inventors: Peter C. Anthony, Menlo Park, CA (US); Linhong Kang, Sunnyvale, CA (US); Andreas Mavrommatis, Edmonton (CA); Lin Tao, Fremont, CA (US); Chenxu Yang, Mountain View, CA (US)

(73) Assignee: Intuit Inc., Mountain View, CA (US)

(21) Appl. No.: 17/360,878

(22) Filed: Jun. 28, 2021

(51) Int. Cl. G06Q 20/40; G06Q 20/02; G06N 20/00; G06K 9/62

(52) U.S. Cl. CPC G06Q 20/4016; G06Q 20/023; G06N 20/00; G06K 9/628

(57) ABSTRACT

Systems and methods for generating one or more comparative features for machine learning based classification are disclosed. A system may be configured to obtain time series data and forecast one or more predicted values based on the time series data. The system may also be configured, for each predicted value of the one or more predicted values, to compare an actual value of the time series data to the predicted value and generate a comparative value of a comparative feature based on the comparison. The comparative feature is to be provided to a machine learning model for a classification task associated with the time series data. The classification task may include determining whether one or more data values in the time series data is fraudulent based on the comparative feature.

### TECHNICAL FIELD

This disclosure relates generally to machine learning based classification systems, including generating comparative features to be used for machine learning based classification.

### DESCRIPTION OF RELATED ART

Machine learning is used for various classification tasks. For example, different machine learning models exist for classifying images, classifying whether an asset will appreciate or depreciate in the future, and determining whether financial activity is fraudulent (e.g., fraudulent credit card activity or bank account activity). The accuracy of a machine learning model is dependent on training the model, and training is dependent on the comprehensiveness of the input data to the model. Therefore, it is desirable to generate a more comprehensive input data set to train the machine learning model.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a computer-implemented method for generating one or more comparative features for machine learning based classification. The example method includes obtaining time series data and forecasting one or more predicted values based on the time series data. The example method also includes comparing an actual value of the time series data to a predicted value (with the actual value corresponding to the predicted value) for each predicted value of the one or more predicted values. The example method also includes generating a comparative value of a comparative feature based on the comparison for each predicted value of the one or more predicted values. The comparative feature is to be provided to a machine learning model for the classification task.

Another innovative aspect of the subject matter described in this disclosure can be implemented in a system for generating one or more comparative features for machine learning based classification. An example system includes one or more processors and a memory storing instructions that, when executed by the one or more processors, cause the system to perform operations. The operations include obtaining time series data and forecasting one or more predicted values based on the time series data. The operations also include comparing an actual value of the time series data to the predicted value (with the actual value corresponding to the predicted value) for each predicted value of the one or more predicted values. The operations also include generating a comparative value of a comparative feature based on the comparison for each predicted value of the one or more predicted values. The comparative feature is to be provided to a machine learning model for the classification task.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example system for generating one or more comparative features for machine learning based classification, according to some implementations.

FIG. 2 shows an illustrative flow chart depicting an example operation for generating one or more comparative features for machine learning based classification, according to some implementations.

FIG. 3 shows an example depiction of daily batch data, according to some implementations.

Like numbers reference like elements throughout the drawings and specification.

### DETAILED DESCRIPTION

Implementations of the subject matter described in this disclosure may be used in classification tasks, such as generating input features to be used in improving the accuracy of a machine learning based classification model.

Classification models are used to classify data for different use cases. For example, an image classification model classifies images into different image types (e.g., classifying images of dogs and cats as an image of a dog or an image of a cat). In another example, a classification model for asset prices (such as home prices, stock prices, or bond prices) may be used to identify an inflection point in the price, an accuracy in predicted asset prices, or other characteristics of the asset price. In a further example, a classification model may be used to identify suspicious activity or fraud in financial transactions for a person or business. A classification model may be configured to classify data into any number of classes, such as binary classification to classify data into two classes, trinary classification to classify data into three classes, or any other multi-class classification to classify data into multiple classes (such as four or more).

Classification models may be machine learning based, and machine learning based classification models may be supervised or unsupervised. Supervised machine learning based classification models use labeled data, with the labels indicating the desired classification to be provided by the model for the corresponding data. The labeled data may be used to train the model until the model approximately reproduces the desired classifications indicated by the labels. For example, for a binary image classification model to classify images as of either object A or object B, each input image may include a flag or other label indicating whether the input image is of object A or object B. The model may classify the images, and the classifications may be compared to the labels to determine the classification error based on the incorrectly classified images. The classification error may be used as feedback to recursively adjust the model, reclassify the images, and determine the new classification error until the error is within an acceptable tolerance.

In another example, a supervised machine learning based classification model may be used for classifying whether a financial transaction or a batch of financial transactions is fraudulent or acceptable in helping to prevent theft from merchants or users. Previous transactions may be used as input data, and the transactions may be labeled as fraudulent or not fraudulent (such as via a flag). The model may be trained to classify transactions or batches of transactions based on the labels until the classification error is within an acceptable tolerance.

In addition to the models being trained based on the classification error, the models may be trained based on other input features of the input data. For example, to train a model to identify fraudulent transactions, input features to train the model may include, e.g., transaction monetary amounts, number of transactions (a transaction count), number of a specific type of transactions, and monetary amounts of specific types of transactions in addition to the labels. The totality of the input data may thus be used to train the model. Fewer input features may cause the trained classification model to have a higher classification error, and more input features (more comprehensive input data) may cause the trained classification model to have a lower classification error. Therefore, there is a need to generate a comprehensive input set of input features to effectively train a machine learning model.

Various implementations of the subject matter disclosed herein provide one or more technical solutions to the technical problem of improving the accuracy of machine learning models. In some implementations, a system is configured to generate one or more input features to be used by a machine learning model in a classification task based on the input data associated with the input features. The generated input features are based on a comparison of a prediction of an input and the actual input (such as a difference between the predicted input and the actual input that is observed), and the generated input features are referred to herein as comparative features. Such comparative features being used to train the machine learning based classification model improves the accuracy of classification by the model as compared to conventionally trained models.

While aspects of the present disclosure are described with reference to supervised machine learning based classification models for clarity purposes, aspects of the present disclosure may also apply to unsupervised machine learning based classification models or other types of machine learning models. Further, while aspects of the present disclosure are described with reference to identifying fraudulent batches of financial transactions for clarity purposes, aspects of the present disclosure may be used for any suitable use case to improve the accuracy of a machine learning model. In addition, while aspects of the present disclosure are described with reference to example binary classification models for clarity purposes, aspects of the present disclosure may be used for any suitable multi-class classification model (such as for a classification task of classifying data into three, four, or more classes).

Various aspects of the present disclosure provide a unique computing solution to a unique computing problem that did not exist prior to the use of computer-implemented machine learning models. As such, implementations of the subject matter disclosed herein are not an abstract idea such as organizing human activity or a mental process that can be performed in the human mind. Preparing, training, and using a machine learning model cannot be performed in the human mind, much less using pen and paper.

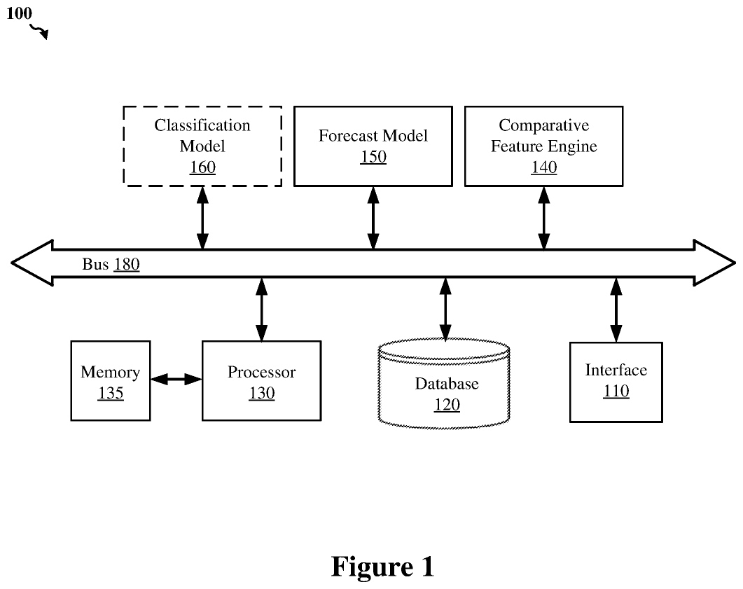

FIG. 1 shows an example system 100 for generating one or more comparative features for machine learning based classification, according to some implementations. The system 100 includes an interface 110, a database 120, a processor 130, a memory 135 coupled to the processor 130, a comparative feature engine 140, and a forecast model 150. In some implementations, the system 100 may include a classification model 160. In some implementations, the various components of the system 100 may be interconnected by at least a data bus 180, as depicted in the example of FIG. 1. In other implementations, the various components of the system 100 may be interconnected using other suitable signal routing resources.

The interface 110 may be one or more input/output (110) interfaces to receive input data (such as time series data) to be used in generating one or more comparative features. The interface 110 may also be used to provide the one or more comparative features generated by the system 100. The interface 110 may also be used to provide or receive other suitable information, such as computer code for updating one or more programs stored on the system 100, internet protocol requests and results, or results from the classification model 160. An example interface may include a wired interface or wireless interface to the internet or other means to communicably couple with user devices, financial institution devices, or other suitable devices. For example, the interface 110 may include an interface with an ethernet cable to a modem, which is used to communicate with an internet service provider (ISP) directing traffic to and from user devices, financial institutions (such as banks, investment firms, credit card companies, etc.), and/or other parties. The interface 110 may also be used to communicate with another device within the network to which the system 100 is coupled. As used herein for a system 100 remote to a user, communicating with a “user” or receiving/providing traffic from/to a “user” may refer to communicating with the user's device (such as a smartphone, tablet, personal computer, or other suitable electronic device) or a financial institution acting on the user's behalf. The interface 110 may also include a display, a speaker, a mouse, a keyboard, or other suitable input or output elements that allow interfacing with the system 100 by a local user or moderator.

In some implementations, the classification task to be performed is to identify fraudulent batches of financial transactions for one or more merchants. As used herein, a merchant refers to a business or individual that provides goods or services for money. Merchants that are small businesses or individuals may use a third party financial management system to handle payments for goods and services. The financial management system may be used to process credit card (CC) debits or credits, automated clearing house (ACH) debits or credits (such as to or from a bank checking account), or other suitable financial payments and provide or reduce the money from a financial account for the merchant (such as a business savings or checking account). In this manner, a plurality of financial transactions may be processed at one time for the merchant's financial account. For example, the financial management system may be used to collect the financial transaction information throughout the business day, and the financial management system may then remove or add the required funds from the merchant's account when processing the batch of transactions at the end of the business day. For example, different CC processing companies may provide services to process all CC transactions during a business day at one time at the end of the day. As used herein, a batch refers to the financial transactions occurring per merchant per day. However, a batch may refer to any suitable grouping of financial transactions (such as per hour or per a group of merchants).

If a fraudulent transaction occurs for a merchant (such as a stolen credit card or stolen checking account information is used to pay for a good or service), the merchant may be required to repay the amount without recouping the good or restitution for the service provided. Therefore, a fraud prevention system may be used to attempt to identify fraudulent financial transactions and prevent loss by the merchant. For example, credit card companies include loss prevention departments to attempt to identify fraud at the time of transaction to prevent loss by the merchant due to possible fraud. In this manner, transactions associated with specific merchants or specific batches may be flagged for further review to prevent losses by the merchants or other parties.

The machine learning based classification model (such as classification model 160) may be used to identify fraudulent financial transactions (such as a daily batch including one or more fraudulent transactions, herein referred to as a fraudulent daily batch). The comparative features to be generated by the system 100 are provided to the classification model to improve the accuracy of the model's classification of batches. In some implementations, the system 100 may be part of a loss prevention system for one merchant or a plurality of merchants using the financial management system.

The financial management system and/or loss prevention system may be local to a specific merchant. For example, the system 100 may be configured as the financial management system to perform batch processing for the specific merchant and as the loss prevention system to identify fraudulent batches. In this manner, the system 100 may include a personal computer or network configured to perform the financial management and/or loss prevention operations for the merchant. Alternatively, the financial management system and/or the loss prevention system may be remote to the merchants. In this manner, the system 100 may be configured to perform all or a portion of the operations for the financial management system and/or for the loss prevention system for one merchant or a plurality of different merchants.

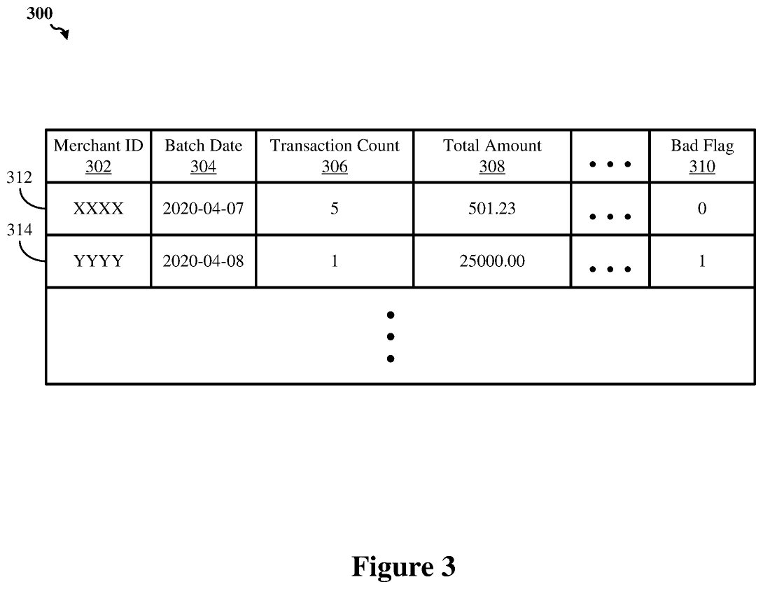

The interface 110 may be configured to communicate with one or more financial institutions and/or the financial management system to obtain input data regarding one or more merchants. For the examples described herein regarding identifying fraudulent batches, input data refers to time series data of batch information regarding the financial transactions for one or more merchants (described in more detail with reference to FIG. 3). While system 100 and the examples are described with reference to identifying fraudulent batches using a machine learning based classification model (e.g., classification model 160), system 100 and aspects of the present disclosure may be used for other suitable classification tasks (such as for image classification or asset price forecasting). In this manner, input data may be any suitable data used to generate the comparative features for improving the accuracy of a machine learning model.

Referring back to FIG. 1, the database 120 may store the input data (such as the time series data) used to generate one or more comparative features. The database 120 may also store predicted values by the forecast model 150, one or more financial management applications, loss prevention applications, the generated comparative features by the comparative feature engine 140, features of the classification model, or other information of the system 100. In some implementations, the database 120 may include a relational database capable of presenting the information as data sets in tabular form and capable of manipulating the data sets using relational operators. The database 120 may use Structured Query Language (SQL) for querying and maintaining the database 120.

The processor 130 may include one or more suitable processors capable of executing scripts or instructions of one or more software programs stored in system 100 (such as within the memory 135). The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processor 130 may include a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the processor 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The comparative feature engine 140 may generate one or more comparative features from the input data and to be used by the machine learning model. As noted above, the input data may be time series data. For example, time series data may be data regarding batches of financial transactions for one or more merchants. The time series data includes a one or more time series of data points (such as one or more series of daily data points), with each time series associated with a different input feature. Example time series of data points (input features) for daily batches for a merchant may include, but are not limited to, one or more of:
a daily count of all monetary transactions for the merchant (such as a total number of CC transactions and ACH transactions for the merchant for the day);
a daily count of ACH total transactions for the merchant (such as a total number of all ACH credits and debits for the merchant for the day);
a daily count of CC total transactions for the merchant (such as a total number of all CC credits and debits for the merchant for the day);
a daily count of ACH sales transactions for the merchant (such as a total number of all ACH payments to the merchant for the day);
a daily count of CC sales transactions for the merchant (such as a total number of all CC payments to the merchant for the day);
a daily monetary amount of ACH total transactions for the merchant (such as the summation of all monies from ACH transactions to be credited to and debited from the merchant's financial account for the day);
a daily monetary amount of CC total transactions for the merchant (such as the summation of all monies from CC transactions to be credited to and debited from the merchant's financial account for the day);
a daily monetary amount of ACH sales transactions for the merchant (such as the summation of all monies from ACH payments to be credited to the merchant's financial account for the day);
a daily monetary amount of CC sales transactions for the merchant (such as the summation of all monies from CC payments to be credited to the merchant's financial account for the day); or
a daily batch monetary amount processed for the merchant (such as the total amount of monies credited to or debited from the merchant's financial account for the day).

The comparative feature engine 140 predicts a value from a time series of data points (such as predicting a future data point for one of the example input features listed above) using the forecast model 150. The comparative feature engine 140 may predict any number of values for any number of input features using the forecast model 150.

The forecast model 150 may be any suitable forecasting model to predict a data value from previous values for the input feature. Example forecasting models include one or more of an autoregressive (AR) model or a window function. Example AR models to predict values from time series data include an autoregressive integrated moving average (ARIMA) model, Facebook®'s Prophet model, or an exponential smoothing model. Example window functions may include a simplified moving average, an exponential moving average, stochastic based smoothing, or a naive forecasting model. Predictions by an example window function may be based on one or more of a mean, a minimum, or a maximum of a predefined number of values in the time series data preceding the predicted value.

The forecast model 150 may be configured to generate a prediction based on one-step ahead forecasting. In this manner, only an immediately succeeding value in time series data is predicted. Alternatively, the forecast model 150 may be configured to generate one or more predictions one or more steps ahead (such as two or more days into the future for an input feature of the time series data used by the forecast model 150).

The comparative feature engine 140 compares a predicted value from the forecast model 150 to the actual value observed for the input feature. Historic input data may be used to generate one or more comparative values. For example, historic input data may include an asset value observed daily for days 1-100, and the historic input data may be used to predict the asset value for one or more days. In a specific example, one or more of the asset values for days 1-19 may be used to predict the asset value for day 20. As a result, the system 100 includes a predicted asset value generated for day 20 and an actual asset value observed for day 20. In this manner, actual values corresponding to the predicted values for an input feature may exist in the historic input data. As used herein, an actual value corresponding to a predicted value may refer to the actual value for a feature that is observed for the same time period for which the predicted value of the feature is predicted (such as for the same day). In this manner, the corresponding actual value and predicted value have a common time reference for a time series. If current input data is used to generate a comparative value (such as an asset value for day 101 (which may be tomorrow) in the previous example or a prediction regarding tomorrow's batch for a merchant), the actual value may be obtained later in time (such as after the business day tomorrow). In this manner, the system 100 may obtain the actual value later in time for the comparative feature engine 140 to compare the actual value to the corresponding predicted value. In some implementations of comparing the actual value to the predicted value, the comparative feature engine 140 may determine a difference between the actual value and the predicted value. The difference may be represented as an absolute difference or may indicate which value is greater than the other (and thus may be negative).

The comparative feature engine 140 may generate a comparative value of a comparative feature based on the comparison. For example, the comparative value may be the difference divided by the actual value. In this manner, the comparative feature may be a time series of one or more comparative values to be used by the machine learning model for classification of the obtained time series data.

In some implementations, the system 100 may include the classification model 160. The classification model 160 is configured to perform a classification task based on the one or more comparative features generated by the comparative feature engine 140 and the other input features of the input data. The classification model 160 is a machine learning based classification model. The comparative features may be used in training the machine learning based classification model. In this manner, the system 100 provides the one or more comparative features (as well as the obtained input data) as inputs to the classification model 160, and the classification model 160 attempts to render a classification (such as predicting the class to which a portion of the input data belongs). The classification model 160 may be any suitable multi-class classification model (such as for a classification task of classifying data into two, three, four, or more classes). While the examples herein describe a binary classification model for clarity, any suitable classification model may be used (such as a trinary classification model or a higher class classification model). As used herein, performing a classification task associated with time series data may refer to classifying portions of the time series data into different classes (such as classifying whether a daily batch is or is not fraudulent or classifying whether an asset is to appreciate in price, depreciate in price, or remain relatively static in price). As noted above, training the model may include recursively adjusting the model and repeating the classification task (e.g., reclassifying the input data (such as reclassifying the obtained time series data)) until the predictions from the model are acceptable.

In some implementations, training of the classification model 160 is supervised. For example, the input data regarding daily batches for one or more merchants may indicate which daily batches are fraudulent (e.g., including a flag indicating whether a daily batch is fraudulent, such as described below with reference to FIG. 3). The system 100 may determine whether the classifications from the classification model 160 are accurate by comparing the classifications to the labels in the input data. Based on the comparison, the incorrect classification of batches may be used as a classification error for training the classification model 160.

In some implementations, the classification model 160 includes a random forest classifier to classify at least a portion of the input data (such as identifying whether one or more batches may be fraudulent). Other examples of a machine learning based classification model 160 may be based, e.g., on one or more of decision trees, logistic regression, nearest neighbors, classification trees, control flow graphs, support vector machines, naïve Bayes, Bayesian Networks, value sets, hidden Markov models, or neural networks configured to generate predictions or classifications for the intended purpose. Other suitable types of classification models may be used, and the classification model 160 is not limited to the provided examples or a specific type of model.

For the example of determining whether a daily batch of financial transactions is fraudulent, the classification model 160 may generate a score (such as from 0 to 1) indicating a likelihood that that the daily batch is fraudulent. The system 100 may then compare the score to a defined threshold to determine whether the daily batch is fraudulent. The threshold may be predefined or may be adjustable (such as based on the user preference to more aggressively identify fraudulent activity). For example, the threshold may be 0.8, 0.95, or another suitable number between 0 and 1 if the generated scores are in a range from 0 to 1.

While the classification model 160 is depicted as being included in the system 100, the classification model may be included in a different system. For example, the system 100 may be configured to generate one or more comparative features and provide the generated features to another system (such as via the interface 110) including the classification model. As such, the system for performing aspects of the present disclosure is not limited to system 100 or a specific configuration of components.

The comparative feature engine 140, the forecast model 150, and the classification model 160 may be implemented in software, hardware, or a combination thereof. In some implementations, the comparative feature engine 140 may be embodied in instructions that, when executed by the processor 130, cause the system 100 to perform operations associated with the comparative feature engine 140. In some implementations, the forecast model 150 may be embodied in instructions that, when executed by the processor 130, cause the system 100 to perform operations associated with the forecast model 150. In some implementations, the classification model 160 may be embodied in instructions that, when executed by the processor 130, cause the system 100 to perform operations associated with the classification model 160. The instructions of one or more of the components 140-160 may be stored in memory 135, the database 120, or another suitable memory. The instructions may be in the Python programming language format or another suitable computer readable format for execution by the system 100 (such as by the processor 130).

The particular architecture of the system 100 shown in FIG. 1 is but one example of a variety of different architectures within which aspects of the present disclosure may be implemented. For example, in other implementations, components of the system 100 may be distributed across multiple devices, may be included in fewer components, and so on. While the below examples of generating one or more comparative features for input to a machine learning based classification model are described with reference to system 100, any suitable system may be used to perform the operations described herein.

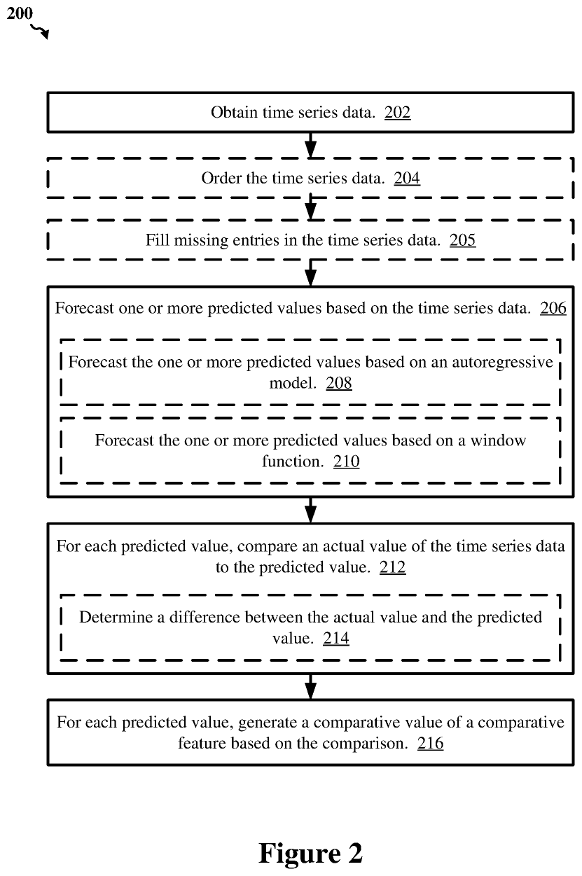

FIG. 2 shows an illustrative flow chart depicting an example operation 200 for generating one or more comparative features for machine learning based classification, according to some implementations. At 202, the system 100 obtains time series data. The times series data may be obtained for a defined time span, for a defined number of data points, since the beginning of collecting data, since last obtaining the time series data, or for any other suitable amount of time. In the example of daily batches of financial transactions, the time series data includes a plurality of daily batch data. Each daily batch of the daily batch data includes one or more data points associated with the daily batch. In some implementations, the system 100 obtains the time series data from a financial management system processing the transactions for one or more merchants. If the financial management system is included in the system 100, the time series data may be generated by the system 100 each business day for a merchant and stored in the database 120 or another suitable memory of the system 100. If the financial management system is communicably coupled to the system 100 (such as being a separate computer, server, or other device coupled to the network coupled to the system 100), the system 100 obtains the time series data via the interface 110 (such as via an ethernet interface or a wireless interface communicably coupled to the financial management system). In some other implementations, the system 100 may obtain the time series data from one or more financial institutions via the interface 110 communicably coupled to one or more financial institution devices storing the information. For example, the system 100 may obtain separate transactions from multiple financial institutions and aggregate the transactions into daily batches. The time series data including daily batch data is described in more detail below with reference to FIG. 3.

FIG. 3 shows an example depiction of daily batch data 300, according to some implementations. Each line of the daily batch data 300 includes data points corresponding to a specific batch (which corresponds to a specific merchant). For example, line 312 corresponds to a daily batch of a first merchant with a merchant identifier (Merchant ID 302) “XXXX” from Apr. 7, 2020 (Batch Date 304). The daily batch includes five overall financial transactions (Transaction Count 306). The total of the five transactions is $501.23 (indicated by the Total Amount 308). Line 314 corresponds to a daily batch of a second merchant with a merchant identifier “YYYY” from Apr. 8, 2020, with one transaction for a total amount of 25,000.00.

The daily batch data 300 may be used for supervised training of the classification model 160. In this manner, each line includes a label (Bad Flag 310) indicating how each daily batch is to be classified. Bad Flag 310 equal to 0 (such as for line 312) indicates that a daily batch is not to be identified as fraudulent. Bad Flag 310 equal to 1 (such as for line 314) indicates that a daily batch is to be identified as fraudulent. In some other implementations, the Bad Flag 310 may be used to indicate whether the classification model 160 identifies the daily batch as fraudulent. In this manner, the system 100 may be able to filter the batches identified as fraudulent for further review (such as by a specialist), count the number of fraudulent batches per merchant over a number of days, or other perform other operations that may assist in preventing loss to the merchant or others.

While the daily batch data 300 is depicted as corresponding to daily batches from different merchants, the daily batch data to be obtained may be for a single merchant. In this manner, the daily batch data may not include Merchant ID 302. Furthermore, while the daily batch data 300 is depicted as a table of lines for clarity, the daily batch data 300 may be in any suitable format. In addition, while some input features are depicted in the example daily batch data 300 (such as Transaction Count 306 and Total Amount 308), any number (such as hundreds) and types of input features may be included. As noted above, other example features include one or more of:
a daily count of all monetary transactions for a merchant (such as a total number of CC transactions and ACH transactions for the merchant for the day);
a daily count of ACH total transactions for the merchant (such as a total number of all ACH credits and debits for the merchant for the day);
a daily count of CC total transactions for the merchant (such as a total number of all CC credits and debits for the merchant for the day);
a daily count of ACH sales transactions for the merchant (such as a total number of all ACH payments to the merchant for the day);
a daily count of CC sales transactions for the merchant (such as a total number of all CC payments to the merchant for the day);
a daily monetary amount of ACH total transactions for the merchant (such as the summation of all monies from ACH transactions to be credited to and debited from the merchant's financial account for the day);
a daily monetary amount of CC total transactions for the merchant (such as the summation of all monies from CC transactions to be credited to and debited from the merchant's financial account for the day);
a daily monetary amount of ACH sales transactions for the merchant (such as the summation of all monies from ACH payments to be credited to the merchant's financial account for the day);
a daily monetary amount of CC sales transactions for the merchant (such as the summation of all monies from CC payments to be credited to the merchant's financial account for the day); or
a daily batch monetary amount processed for the merchant (such as the total amount of monies credited to or debited from the merchant's financial account for the day).

While the example time series data is depicted as daily batch data for one or more merchants, the time series data may be any suitable type for a classification task. For example, the time series data may be regarding asset prices, population growth, temperature change, or other data tracked over time. Additionally or alternatively, the time series data may be for any suitable time units or periods. While the time series data is depicted as daily batch data with data points existing on a daily basis (one data point per feature per day), other suitable time units may include hourly, weekly, monthly, yearly, and so on. As such, while the examples may be described with reference to determining whether a daily batch is fraudulent for each daily batch, a classification model may be used to determine whether fraud exists for any size batch using any suitable unit of time (such as determining whether a weekly batch of transactions is fraudulent). The examples herein are described with reference to daily batch data for clarity in describing generating one or more comparative features, and the present disclosure is not limited to the provided examples.

The time series data may be in any suitable format for processing by the system 100. For example, the time series data may be included in one or more JavaScript Object Notation (JSON) files or objects. In another example, the time series data may be in SQL compliant data sets for filtering and sorting by the system 100 (such as by processor 130).

The time series data, when obtained, may be out of order with reference to time. For example, the daily batch data 300 may be out of order with reference to the Batch Date 304 such that a line is associated with a date not between the dates associated with the lines immediately preceding and succeeding the line. In some implementations of step 202, the system 100 may obtain daily batch data for different merchants and aggregate the information into one group of daily batch data. In this manner, the daily batch data across the different merchants may be initially organized with daily batches for each merchant grouped together, but the daily batches may be out of order based on date.

In some implementations, the system 100 may order the time series data (204). For example, referring to FIG. 3, the system 100 may order the daily batch data 300 so that the lines ascend or descend in chronological order based on Batch Date 304.

The time series data, when obtained, may also be missing entries for one or more days for one or more merchants. For example, a small store may be closed when the owner goes out of town or is otherwise unable to man the store, for religious or federal holidays, or for designated days of the week (such as every Monday). In this manner, a daily batch for the merchant may not exist for those days. In another example, a financial institution or the financial management system may be offline or there may otherwise be an error in obtaining daily batch data such that one or more entries may be missing when obtaining the daily batch data.

In some implementations, the system 100 may fill missing entries in the time series data (205). In some implementations regarding daily batch data, the system 100 may fill missing entries to ensure entries exist for every calendar day for a merchant. In some other implementations, the system 100 may fill to ensure entries exist for every business day for a merchant.

The system 100 may zero fill missing entries. For example, the system 100 may generate a new line in daily batch data 300 corresponding to a missing daily batch, enter the date corresponding to the missing entry in the Batch Date 304 and enter the Merchant ID 302, and fill the remaining items in the line with 0. The system 100 may also set the Bad Flag 310 to 0. In some other implementations, the system 100 may fill missing entries with the preceding or succeeding entry value, an average or median of a number of preceding or succeeding entry value, or with any other suitable values to ensure no missing entries in the time series data. To note, steps 204 and 205 in example method 200 are optional steps that may or may not be performed by the system 100. As such, the system 100 is not required to perform such steps to perform aspects of the present disclosure.

At 206, the system 100 forecasts one or more predicted values based on the time series data. The forecast may be performed using the forecast model 150. For example, the system 100 may forecast a predicted daily batch for a specific Batch Date 304 for Merchant ID “XXXX.” In forecasting the predicted daily batch, the system 100 may predict a predicted value for Total Amount 308 for the Batch Date 304 for Merchant ID “XXXX.” The forecast may be for a preexisting daily batch included in the daily batch data 300, or the forecast may be for a daily batch not included in the daily batch data 300 (such as for a future date or to otherwise be obtained at a future time by the system 100). The system 100 may forecast a predicted value for any number of predicted features for a daily batch and may forecast any number of daily batches (such as for different merchants or for the same merchant). In some implementations, each predicted value is based on one-step-ahead forecasting. For example, the system 100 may forecast predicted values only for a predicted daily batch for the next business day for each merchant (and not for daily batches further into the future). In some other implementations, a predicted value may be for further steps into the future (such as more than one day into the future for a predicted daily batch).

The forecast model 150 configured to forecast the one or more predicted values may include one or more of an autoregressive model or a window function. In some implementations, the system 100 may forecast the one or more predicated values based on an autoregressive model (208). Example autoregressive models may include one or more of an ARIMA model, Facebook®'s Prophet model, or an exponential smoothing model. The above example models are univariate autoregressive models with the predicted value being based on input values corresponding to the predicted value for the input feature. As noted above, a value corresponding to a predicted value refers to a value observed for a feature for a same time period for which the predicted value is predicted (having a common time reference, such as the input value and the predicted value of the input feature being for the same day). For example, a predicted value for Total Amount 308 for a predicted daily batch for Merchant ID “XXXX” is based on actual values of Total Amount 308 for other daily batches for Merchant ID “XXXX” in the daily batch data 300 without reference to any exogenous variables or features besides the Total Amount 308. Additionally or alternatively, the forecast model 150 may include a multivariate autoregressive model. In this manner, the system 100 may input values from other features into the forecast model 150 as exogenous regressors to the predicted value to be forecast. For example, the system 100 may input corresponding Transaction Count 306 values as an exogenous regressor to predict a Total Amount 308 for a predicted daily batch.

If the forecast model 150 includes a window function, the system 100 may forecast the one or more predicted values based on the window function (210). An example window function includes a naive forecasting model. For a naive forecasting model, the system 100 may use the immediately preceding time series entry as the predicted value. For example, the system 100 may use values from an immediately preceding date's daily batch for a merchant as the predicted values for a predicted daily batch. However, any suitable window function may be used, such as a moving average. In some implementations, the window function is based on one or more of a mean, a minimum, or a maximum of a predefined number of values (such as N values, with integer N greater than or equal to 1) in the time series data preceding the predicted value. In a simplified example, if N is 3, the forecast model 150 may be a moving average to forecast a predicted value of a Total Amount 308 for a predicted daily batch for a merchant as a mean of the three values of the Total Amount 308 for the three immediately preceding daily batches for the merchant in the daily batch data 300. N may be predefined, variable, or otherwise configurable in any suitable manner.

A predicted value may be forecast for any feature/time series in the time series data. For example, for forecasting a next day's predicted daily batch for a merchant, the system 100 may forecast one or more of:
a daily count of all monetary transactions for a merchant for the next business day;
a daily count of ACH total transactions for the merchant for the next business day;
a daily count of CC total transactions for the merchant for the next business day;
a daily count of ACH sales transactions for the merchant for the next business day;
a daily count of CC sales transactions for the merchant for the next business day;
a daily monetary amount of ACH total transactions for the merchant for the next business day;
a daily monetary amount of CC total transactions for the merchant for the next business day;
a daily monetary amount of ACH sales transactions for the merchant for the next business day;
a daily monetary amount of CC sales transactions for the merchant for the next business day; or
a daily batch monetary amount to be processed for the merchant for the next business day.

While some examples of a forecast model 150 are provided for clarity, the system 100 may use any suitable forecast model to forecast the one or more predicted values. As such, the system 100 is not required to perform steps 208 or 210 to perform aspects of the present disclosure described herein.

At 212, for each predicted value, the system 100 compares an actual value of the time series data to the predicted value. For example, if the system 100 forecasts a predicted value for Total Amount 308 for Merchant ID “XXXX” for Batch Date 2020 Apr. 7 (using total amounts from daily batches prior to Apr. 7, 2020, for the merchant associated with Merchant ID “XXXX”), the system 100 compares the actual value “501.23” from the actual daily batch in the daily batch data 300 to the predicted value. If the predicted value is for a daily batch that is not yet obtained (such as for a future date), the system 100 may compare the actual value to the predicted value in the future after obtaining the daily batch information associated with the predicted value. For example, a previous day's predictions for a present day may be compared by the system 100 to the present day's actual values once obtained (such as after the business day when daily batches are processed).

In some implementations, the system 100 determines a difference between the actual value and the predicted value (214). For example, if the predicted value is “600.00” for the Total Amount 308 for a predicted daily batch for date Apr. 7, 2020, for the merchant with Merchant ID “XXXX,” the system 100 may determine the difference between “501.23” and “600.00”. In some implementations, the difference is the actual value minus predicted value (e.g., 501.23−600=−98.77). In some implementations, the difference is the magnitude of the actual value minus predicted value (e.g., |501.23−600|=98.77). While some examples are provided for clarity purposes, the comparison may be performed in any suitable manner, and the system 100 is not required to perform step 214 to perform aspects of the present disclosure described herein.

At 216, for each predicted value, the system 100 generates a comparative value of a comparative feature based on the comparison. In some implementations, the comparative value is the difference divided by the actual value. In some implementations, the comparative value may be the difference divided by the predicted value. As noted above, the system 100 may determine the difference in step 214. Referring to the above example regarding the difference for the Total Amount 308 being determined as 98.77, the system 100 may generate the comparative value as 98.77/501.23 (which approximately equals 0.197). The system 100 may round the value to a defined place value (such as to the nearest thousandth) to generate the comparative value. The comparative value may be in any suitable format, such as in decimal form or indicating a percentage.

In another example, if the system 100 forecasts a daily batch monetary amount to be processed for the merchant for the next business day, after the next business day (when the actual daily batch monetary amount for that day is processed and the value is obtained by the system 100), the system 100 determines the difference between the predicted daily batch monetary amount and the actual daily batch monetary amount and divides the difference by the actual amount (or by the predicted amount in some other implementations).

In this manner, a comparative feature may be its own time series including values indicating a difference between actual and predicted values over time (such as for one or more of the above features in a daily batch). Each comparative value of the comparative feature is associated with a specific time of the time series data (such as a specific daily batch).

As noted above with reference to step 208, one or more predicted values may be based on an autoregressive model. To note, autoregressive models may be useful in capturing or otherwise identifying trajectories in a time series. For example, an autoregressive model may be used to show a downward or upward trend in values over time (such as showing a rate of change (RoC) over time). In this manner, a comparative feature based on forecasts from an autoregressive model and the corresponding actual values can reflect how the actual value varies from what would be expected based on the trajectory of the time series. The comparative feature may thus be a time series indicating such variation between the expected value and the actual value over time.

While not shown in FIG. 2, the system 100 may store the values of the one or more comparative features with the time series data. For example, comparative values for a daily batch in the daily batch data 300 may be stored as entries in the line of values for the daily batch. In this manner, each line may have one or more additional fields for different comparative features to indicate the associated comparative values determined for the daily batch. In some other implementations, the comparative features may be stored in data objects separate to the time series data (such as a separate data set or other data objects than daily batch data 300). The comparative features may be stored in the database 120 or another suitable memory of the system 100.

The system 100 may generate a comparative feature for any input feature in the time series data. For example, if the time series data includes 100 input features (100 time series) to be input to the classification model 160, the system 100 may generate up to 100 different comparative features using a univariate forecast model 150 or single metric for aggregation (or more than 100 different comparative features using multiple metrics for aggregation (e.g., using a mean and using a minimum for different aggregations of an input feature) or using a multivariate forecast model 150 (which may theoretically produce up to 100 factorial new features)). In a specific example, if a comparative feature is generated for each of the ten example input features listed above for daily batches (e.g., daily count of all monetary transactions, daily count of ACH total transactions, etc.), the system 100 may generate a comparative feature for each of the ten example input features for a merchant. In this example, ten additional features per merchant may be provided to a machine learning model for performing the classification task associated with time series data of classifying whether one or more of the daily batches are fraudulent for a merchant. While generating one comparative feature is depicted in the example method 200, as noted above, the system 100 may generate any number of comparative features. In some implementations, the system 100 may perform one or more steps of method 200 multiple times to generate a plurality of comparative features.

As noted above, the machine learning model may be any suitable model, such as a random forest classifier. If the system 100 includes the machine learning based classification model 160, the system 100 may train the classification model 160 with the one or more comparative features (in addition to the obtained input features) to improve the accuracy of the classification model 160. As noted above, the classification model 160 may be any suitable multi-class classification model for a classification task that may be associated with the obtained time series data (such as classifying portions of the time series data into two, three, four, or more classes). If the system 100 does not include the machine learning model, the system 100 may provide the one or more comparative features (via the interface 110) to a communicably coupled device including the machine learning model for classification. For example, the system 100 may provide the daily batch data 300 including the comparative features generated by the system 100 to another system including the classification model, and the other system may input the comparative features (in addition to the input features) to the model. The additional comparative features input to the machine learning model increase the comprehensiveness of the input data and thus improve the accuracy of classifications by the model after training (such as improving the accuracy in determining whether one or more daily batches of the daily batch data for a merchant is fraudulent based on the one or more comparative features). While improving the accuracy of classifications is described in the above examples (such as classifying whether a daily batch is fraudulent), improving other types of forecasts by a machine learning model may be performed using aspects of the present disclosure. As such, the present disclosure is not limited to a specific type of machine learning model or use case.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles and the novel features disclosed herein.

What is claimed is:

1. A computer-implemented method for generating one or more comparative features for machine learning based classification, the method comprising:
obtaining time series data;
forecasting one or more predicted values based on the time series data; and
for each predicted value of the one or more predicted values:
comparing an actual value of the time series data to the predicted value, wherein the actual value corresponds to the predicted value; and
generating a comparative value of a comparative feature based on the comparison, wherein the comparative feature is to be provided to a machine learning model for a classification task associated with the time series data.

2. The method of claim 1, wherein comparing the actual value to the predicted value includes determining a difference between the actual value and the predicted value.

3. The method of claim 2, wherein the comparative value is the difference divided by the actual value.

4. The method of claim 1, wherein forecasting the one or more predicted values is based on one of an autoregressive model or a window function.

5. The method of claim 4, wherein the autoregressive model includes one or more of:
an autoregressive integrated moving average (ARIMA) model;
a Prophet model; or
an exponential smoothing model.

6. The method of claim 4, wherein the window function for each predicted value is based on one or more of a mean, a minimum, or a maximum of a predefined number of values in the time series data preceding the predicted value.

7. The method of claim 4, wherein the window function includes a naive forecasting model.

8. The method of claim 1, wherein forecasting each predicted value of the one or more predicted values is based on one-step-ahead forecasting.

9. The method of claim 1, further comprising zero filling missing entries in the time series data before forecasting the one or more predicted values.

10. The method of claim 1, wherein:
the time series data includes daily batch data for one or more merchants ordered by date, wherein the daily batch data includes one or more of:
a daily count of all monetary transactions for a merchant;
a daily count of automated clearing house (ACH) total transactions for the merchant;
a daily count of credit card (CC) total transactions for the merchant;
a daily count of ACH sales transactions for the merchant;
a daily count of CC sales transactions for the merchant;
a daily monetary amount of ACH total transactions for the merchant;
a daily monetary amount of CC total transactions for the merchant;
a daily monetary amount of ACH sales transactions for the merchant;
a daily monetary amount of CC sales transactions for the merchant; or
a daily batch monetary amount processed for the merchant; and
the classification task associated with the time series data includes determining whether one or more daily batches of the daily batch data for the merchant is fraudulent based on the comparative feature.

11. A system for generating one or more comparative features for machine learning based classification, the system comprising:
one or more processors; and
a memory storing instructions that, when executed by the one or more processors, causes the system to perform operations comprising:
obtaining time series data;
forecasting one or more predicted values based on the time series data; and
for each predicted value of the one or more predicted values:
comparing an actual value of the time series data to the predicted value, wherein the actual value corresponds to the predicted value; and
generating a comparative value of a comparative feature based on the comparison, wherein the comparative feature is to be provided to a machine learning model for a classification task associated with the time series data.

12. The system of claim 11, wherein the operations for comparing the actual value to the predicted value include determining a difference between the actual value and the predicted value.

13. The system of claim 12, wherein the comparative value is the difference divided by the actual value.

14. The system of claim 11, wherein forecasting the one or more predicted values is based on one of an autoregressive model or a window function.

15. The system of claim 14, wherein the autoregressive model includes one or more of:
an autoregressive integrated moving average (ARIMA) model;
a Prophet model; or
an exponential smoothing model.

16. The system of claim 14, wherein the window function for each predicted value is based on one or more of a mean, a minimum, or a maximum of a predefined number of values in the time series data preceding the predicted value.

17. The system of claim 14, wherein the window function includes a naive forecasting model.

18. The system of claim 11, wherein forecasting each predicted value of the one or more predicted values is based on one-step-ahead forecasting.

19. The system of claim 11, wherein the operations further comprise zero filling missing entries in the time series data before forecasting the one or more predicted values.

20. The system of claim 11, wherein:
the time series data includes daily batch data for one or more merchants ordered by date, wherein the daily batch data includes one or more of:
a daily count of all monetary transactions for a merchant;
a daily count of automated clearing house (ACH) total transactions for the merchant;
a daily count of credit card (CC) total transactions for the merchant;
a daily count of ACH sales transactions for the merchant;
a daily count of CC sales transactions for the merchant;
a daily monetary amount of ACH total transactions for the merchant;
a daily monetary amount of CC total transactions for the merchant;
a daily monetary amount of ACH sales transactions for the merchant;
a daily monetary amount of CC sales transactions for the merchant; or
a daily batch monetary amount processed for the merchant; and
the classification task associated with the time series data includes determining whether one or more daily batches of the daily batch data for the merchant is fraudulent based on the comparative feature.
